(19) United States
(12) Patent Application Publication
(10) Pub. No.: US 2003/0130786 A1
(43) Pub. Date: Jul. 10, 2003

(54) Patient tracking system and method

(76) Inventors: Hakan M. Ilkin, Pittsburgh, PA (US); Evan Michael Indianer, Pittsburgh, PA (US)

Correspondence Address: KIRKPATRICK & LOCKHART LLP, 535 SMITHFIELD STREET, PITTSBURGH, PA, 15222, US

(21) Appl. No.: 10/339,607

(22) Filed: Jan. 9, 2003

Related U.S. Application Data
(63) Continuation of application No. 09/475,919, filed on Dec. 30, 1999, now abandoned.

(51) Int. Cl. G01C 21/28

(52) U.S. Cl. 701/205; 701/207

(57) ABSTRACT

A computer-assisted method of tracking a patient through a perioperative process. The process includes entering a location of the patient into a patient tracking system, entering at least one procedural time into the patient tracking system, and tracking, via a terminal connected to a distributed computer network, the patient through the perioperative process based on the location of the patient and the procedural time.

### CROSS-REFERENCE TO RELATED APPLICATIONS

(Not applicable)

### STATEMENT REGARDING FEDERALLY SPONSORED RESEARCH

(Not applicable)

### BACKGROUND OF THE INVENTION

1. Field of the Invention

The present invention is directed generally to a system and method for tracking a patient and, more particularly, to a system and method for tracking a patient through a perioperative process.

2. Description of the Background

As a patient advances through a perioperative process, it is difficult for the hospital staff to track the progress of the patient. Staff members must monitor the patient using a combination of verbal communications via telephone calls and in-person conversations, and personal observations.

A real-time patient tracking system is described in: Rotondi et al., “Benchmarking the Perioperative Process. I. Patient Routing Systems: A Method for Continual Improvement of Patient Flow and Resource Utilization”, J. Clin. Anesth., vol. 9, March 1997, pp. 159-69; Williams et al., “Benchmarking the Perioperative Process. II. Introducing Anesthesia Clinical Pathways to Improve Processes and Outcomes and to Reduce Nursing Labor Intensity in Ambulatory Orthopedic Surgery”, J. Clin. Anesth., vol. 10, November 1998, pp. 561-68; and Williams et al., “Benchmarking the Perioperative Process. III. Effects of Regional Anesthesia Clinical Pathway Techniques on Process Efficiency and Recovery Profiles in Ambulatory Orthopedic Surgery”, J. Clin. Anesth., vol. 10, November 1998, pp. 570-77. The described system uses barcode and client-server, or local area network (LAN) technology, to track the progress of patients during the perioperative process. The described system does not use the distributed capabilities of the Internet to allow access to the data in the system. Further, the described system does not have a means for tracking delays that are inherent in the perioperative process.

Thus, there is a need for a system and method for tracking a patient through the perioperative process that use the distributed capabilities of the Internet so that, for example, hospital staff and patient families can view the progress of the patient through the process. There is also a need for a system and method for tracking a patient through the perioperative process that allow for delays to be entered into the system so that the patient's progress can be tracked in light of such delays. There is a further need for a system and method for tracking a patient through the perioperative process that use wireless technologies to register the patient at various stages of the process.

### SUMMARY OF THE INVENTION

The present invention is directed to a computer-assisted method of tracking a patient through a perioperative process. The process includes entering a location of the patient into a patient tracking system, entering at least one procedural time into the patient tracking system, and tracking, via a terminal connected to a distributed computer network, the patient through the perioperative process based on the location of the patient and the procedural time.

The present invention represents a substantial advance over prior systems and methods of tracking patients through the perioperative process. The present invention has the advantage that it allows for the tracking of a patient through the perioperative process using the distributed capabilities of the Internet so that, for example, hospital staff and patient families can view the progress of the patient through the process using a distributed computer network, such as the Internet or the hospital's intranet. The present invention also has the advantage that it allows for the tracking of a patient through the perioperative process while allowing for delays to be entered into the system so that the patient's progress can be tracked in light of such delays. The present invention has the further advantage that it allows for the tracking of a patient through the perioperative process using wireless technologies to register the patient at various stages of the process.

### BRIEF DESCRIPTION OF THE DRAWINGS

For the present invention to be clearly understood and readily practiced, the present invention will be described in conjunction with the following figures, wherein:

FIG. 1 is a diagram illustrating the stages of a typical perioperative process;

FIG. 2 is a diagram illustrating a patient tracking system;

FIG. 3 is a diagram illustrating an embodiment of a flow through the system of FIG. 2; and

FIGS. 4-15 are screen printouts illustrating an example of a software implementation of the system of FIG. 2.

### DETAILED DESCRIPTION OF THE PREFERRED EMBODIMENT

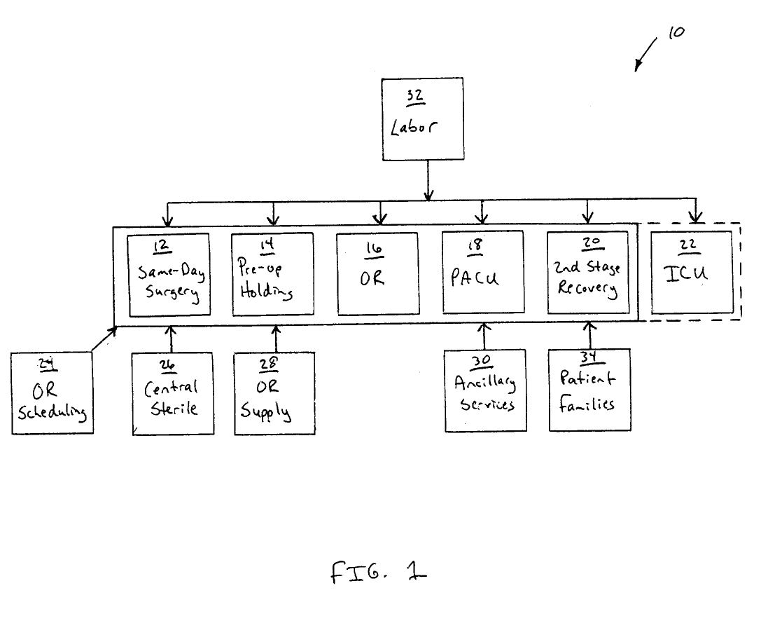

FIG. 1 is a diagram illustrating the stages of a typical perioperative process 10. An ambulatory patient enters same-day surgery 12, and then may enter a pre-op holding area 14. The patient then enters the operating room 16, followed by a post-anesthesia care unit 18 and a second-stage recovery room 20. Optionally, the patient may proceed from the operating room 16 to an intensive care unit 22. An inpatient may enter a pre-op holding area 14. The patient then enters the operating room 16, followed by a post-anesthesia care unit 18. Following the post-anesthesia care unit 18, the patient returns to an inpatient bed. The perioperative process 10 is supported by the hospital's operating room scheduling process 24, a central sterile area 26, an operating room supply area 28, and various ancillary services 30. The process 10 is also supported by the various labor components 32 of the hospital such as, for example, surgeons, nurses, anesthesiologists, technicians, supply technicians, managers, and transport personnel. Patient families 34 are also involved in the process 10 because they are interested in monitoring the process 10.

The perioperative process 10 can be monitored by tracking some or all of the procedural times and any delay codes at each stage. Table 1 illustrates procedural times, Table 2 illustrates procedural and scheduling definitions and time periods, and Table 3 illustrates utilization and efficiency indices, including delays, that can be tracked. The entries in Tables 1, 2, and 3 are described in further detail in Donham et al., “Glossary of Times Used for Scheduling and Monitoring of Diagnostic and Therapeutic Procedures”, Supplement to the American Journal of Anesthesiology, September/October 1996, pp. 4-9, which is incorporated herein by reference.

TABLE 1
PROCEDURAL TIMES

| | |
|---|---|
| 1.1 | Patient In Facility |
| | (PIF) |
| 1.2 | Patient Ready For |
| | Transport (PRT) |
| 1.3 | Patient Sent For (PF) |
| 1.4 | Patient Available (PA) |
| 1.5 | Room Set-up Start |
| | (RSS) |
| 1.6 | Anesthesia Start (AS) |
| 1.7 | Room Ready (RR) |
| 1.8 | Patient In Room (PIR) |
| 1.9 | Anesthesiologist, First |
| | Available (AFA) |
| 1.10 | Procedure Physician, |
| | First Available (PPFA) |
| 1.11 | Anesthesiologist of |
| | Record In (ARI) |
| 1.12 | Anesthesia Induction |
| | (AI) |
| 1.13 | Anesthesia Ready (AR) |
| 1.14 | Position/Prep Start (PS) |
| 1.15 | Prep Completed (PC) |
| 1.16 | Procedure Physician of |
| | Record In (PPRI) |
| 1.17 | Procedure/Surgery Start |
| | Time (PST) |
| 1.18 | Procedure/Surgery |
| | Conclusion Begun (PCB) |
| 1.19 | Procedure Physician of |
| | Record Out (PPRO) |
| 1.20 | Procedure/Surgery Finish |
| | (PF) |
| 1.21 | Patient Out of Room |
| | (POR) |
| 1.22 | Room Clean-up Start |
| | (RCS) |
| 1.23 | Arrival in |
| | Postanesthesia Care |
| | Unit/Intensive Care Unit |
| | (APACU) |
| 1.24 | Anesthesia Finish (AF) |
| 1.25 | Room Clean-up |
| | Finished (RCF) |
| 1.26 | Ready-for-Discharge |
| | From Postanesthesia Care |
| | Unit (RDPACU) |
| 1.27 | Discharge From |
| | Postanesthesia Care Unit |
| | (DPACU) |
| 1.28 | Arrival in Same-Day |
| | Surgery Recovery Unit |
| | (ASDR) |
| 1.29 | Ready-for-Discharge |
| | From Same-Day Surgery |
| | Recovery Unit (RDSDSR) |
| 1.30 | Discharge From Same- |
| | Day Surgery Recovery |
| | Unit (DSDSR) |

TABLE 2
PROCEDURAL AND SCHEDULING DEFINITIONS
AND TIME PERIODS

| | |
|---|---|
| 2.1 | Anesthesia Preparation |
| | Time (APT) |
| 2.2 | Average Case Length |
| | (ACL) |
| 2.3 | Block Time (BT) |
| 2.4 | Case Time (CT) |
| 2.5 | Early Start Hours (ESH) |
| 2.6 | Evening/Weekend/Holiday |
| | Hours (EWHH) |
| 2.7 | In-Own Block Hours |
| | (IBH) |
| 2.8 | Open Time (OT) |
| 2.9 | Outside-Own Block |
| | Hours (OBH) |
| 2.10 | Overrun Hours (OVRH) |
| 2.11 | Released Time (RT) |
| 2.12 | Resource Hours (RH) |
| 2.13 | Room Clean-up Time |
| | (RCT) |
| 2.14 | Room Close (RC) |
| 2.15 | Room Open (RO) |
| 2.16 | Room Set-up Time |
| | (RST) |
| 2.17 | Service |
| 2.18 | Surgical Preparation |
| | Time (SPT) |
| 2.19 | Start Time (ST) |
| 2.20 | Total Cases (TC) |
| 2.21 | Total Hours (TH) |
| 2.22 | Turnover Time (TOT) |

TABLE 3
UTILIZATION AND EFFICIENCY INDICES

| | |
|---|---|
| 3.1 | Adjusted Percent |
| | Service Utilization (ASU) |
| 3.2 | Adjusted Percent |
| | Utilized Resource Hours |
| | (AURH) |
| 3.3 | Potential Causes of |
| | Delays |
| 3.3.1 | Patient Issues |
| 3.3.2 | System Issues |
| 3.3.3 | Practitioner Issues |
| 3.4 | Early Start |
| 3.4.1 | Early Start With Overlap |
| 3.4.2 | Early Start Without |
| | Overlap |
| 3.5 | Late Start |
| 3.5.1 | Late Start With No |
| | Interference |
| 3.5.2 | Late Start With |
| | Interference |
| 3.6 | Overrun |
| 3.7 | Productivity Index (PI) |
| 3.8 | Raw Utilization (RU) |
| 3.9 | Room Gap |
| 3.9.1 | Empty Room (or Late |
| | Start) Gap (LSG) |
| 3.9.2 | Between Case Gaps |
| | (BCG) |
| 3.93 | End of Schedule Gaps |
| | (ESG) |
| 3.9.4 | Total Gap Hours (TGH) |

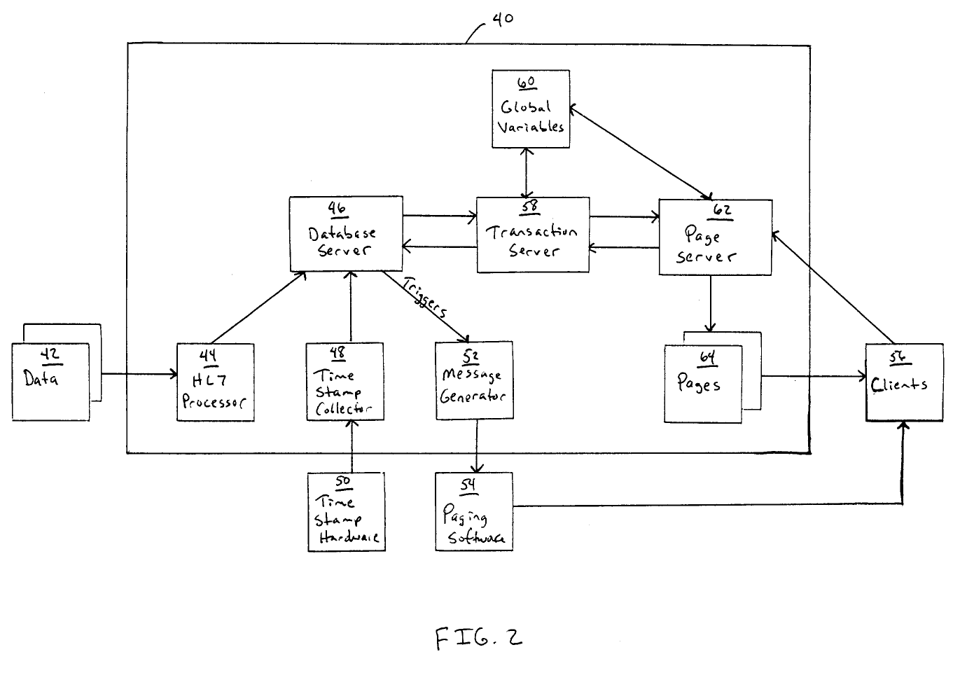

FIG. 2 is a diagram illustrating a patient tracking system 40. The system 40 tracks the progress of a patient through the perioperative process by collecting times associated with the entries contained in Tables 1, 2, and 3 at various stages of the process. The system 40 may be implemented as an Internet-enabled system which can track a patient's progress in real time. The system can be implemented using, for example, a Microsoft Distributed Network Architecture (DNA) arrangement.

The system 40 receives data 42 from outside sources in, for example, Health Level 7 (HL7) format. The data 42 could be, for example, scheduling data received from a hospital scheduling system. The data 42 are processed by an HL7 processor 44, which converts the data into database tables, and are stored by a database server 46. The database server could be, for example, a Microsoft SQL server.

A time stamp collector 48 collects time stamps generated by time stamp hardware 50 for storage by the database server 46. Pieces of the hardware 50 can be located in multiple rooms in the hospital in which patients will travel during the perioperative process. The hardware 50 can be any type of hardware suitable to collect time stamps which track the patient through the perioperative process. For example, the hardware 50 can consist of devices that read passive radio frequency badges that accompany patients through the perioperative process. Alternatively, the hardware 50 can be infrared receivers that detect infrared (IR) signals transmitted by active infrared transmitters which accompany the patients through the perioperative process. In either case, when the passive RF or IR signals are detected by the hardware 50, the time is recorded by the time stamp collector 48 and stored by the database server 46. Each of the various pieces of the hardware 50 has a unique location identifier associated with it so that the location of the patient as well as the time stamp may be stored by the database server 46.

A message generator 52 receives triggers, or requests, from the database server and transmits requests to external paging software 54. The paging software can be, for example, the Hiplink™ Paging Software sold by Cross Communications, Inc. Thus, when appropriate, the message generator 52 generates a paging message, text message, web message, or email paging message and transmits the message to the paging software 54. The paging software 54 then transmits the message via the appropriate medium (e.g. a wireless paging network) to the appropriate client 56. The client 56 may be a device that is used by, for example, the hospital staff or patients' families to track the progress of the patient in the perioperative process. Thus, the client 56 can be, for example, a web browser on a personal computer, a personal digital assistant (PDA), or a wireless telecommunications device such as a pager. The database server 46 would thus generate a trigger when a patient entered a specific stage of the perioperative process. For example, the appropriate surgeon could be notified via a pager when a patient enters the operating room. Also, a patient's family could be notified via a pager when the patient enters the post-anesthesia care unit.

A transaction server 58 is in communication with the database server 46. The transaction server 58 can be, for example, a Microsoft Transaction Server that uses component object models (COM) and distributed component object models (DCOM). The transaction server 58 sets global variables 60 for processing purposes.

A page server 62 is in communication with the transaction server 58. The page server 62 generates pages 64 for use by the clients 56 when the clients 56 request information or data from the system 40. The page server 62 can be, for example, a Microsoft Internet Information Server (IIS) using active server pages (ASP). The pages 64 can be, for example, HTML, DHTML, XML pages, VisualBasic Scripting, or JavaScript. Each of the clients 56 that are web browsers may view updated information by, for example, refreshing at certain intervals such as, for example, one-minute intervals. Alternatively, the page server 60 could “push” updated data to the clients 56 as the data are updated. Thus, if a client 56 is displaying an HTML page 64 which illustrates a GANTT chart of the status of the various operating rooms in the hospital and the underlying data for the page 64 are updated in the database server 46 every 30 seconds, the client would receive a fresh HTML page 64 with the updated data every 1 minute either by refreshing or by a “push” by the page server 62.

The clients 56 can be in communication with the system 40 via, for example, the Internet or an intranet. The clients 56 can be HIPAA compliant such that data transmitted from the clients 56 to the system 40 is secure. Such security prevents, for example, patient families from viewing information that does not relate to their family member.

Data such as time stamps may be entered via the clients 56 and stored in the database 46. Thus, a hospital staff member may enter a time stamp into one of the clients 56 when a patient enters a room such as, for example, an operating room that does not have a piece of the time stamp hardware 50.

It can be understood that the servers 46, 58, and 62 can be resident on one or multiple computers. Such a computer or computers can be, for example, a RISC System 6000 Workstation sold by the IBM Corporation or a Dell server that uses Microsoft Windows NT Server as the operating system.

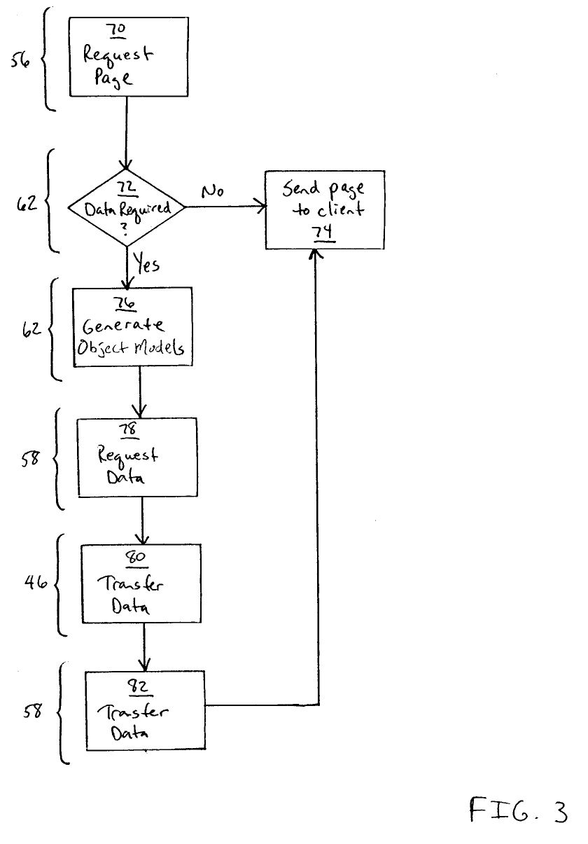

FIG. 3 is a diagram illustrating an embodiment of a flow through the system 40 of FIG. 2. At step 70, one of the clients 56 requests a page 64 from the page server 62. At step 72, the page server 62 determines if the page requires data to be retrieved to “build” the page 64. If the page 64 does not require data, the page server 62 serves the page 64 to the requesting client 56 at step 74. If the page requires data, the page server 62 generates COM or DCOM objects to request the data at step 76. The transaction server 58 requests the data from the database server 46 at step 78 and the database server transfers the data (and/or HTML) to the transaction server 58 at step 80. The transaction server 58 then transfers the data (and/or HTML) to the page server 62 at step 82 and the page server 62 serves the page 64, including the retrieved data (and/or HTML) to the requesting client 56 at step 74.

The system 40 can also handle storage of data (e.g. a time stamp input via one of the clients 56) in a similar manner as described in conjunction with FIG. 2. The data are transferred in the form of a request from the page server 62 to the transaction server 58, and the transaction server 58 transfers the data to the database server 46 for storage.

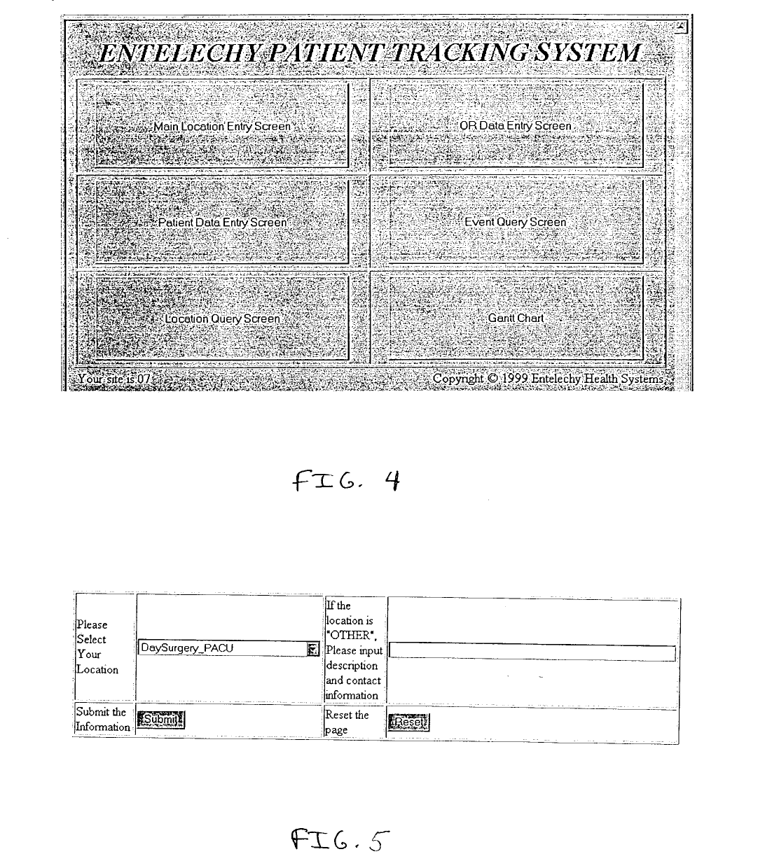

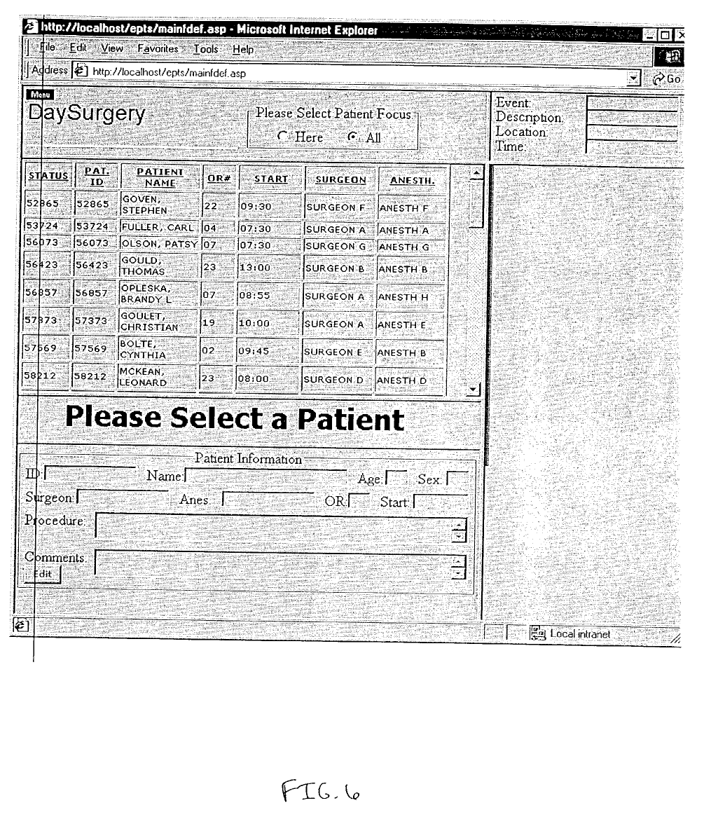

FIGS. 4-15 are screen printouts illustrating an example of a software implementation of the system 40 of FIG. 2. The screen printouts of FIGS. 4-15 can appear on user computers via the clients 56. FIG. 4 is a screen printout of a main screen that is accessed when the system 40 is first started. The screen of FIG. 5 could appear when the system 40 is first used. The system 40 is thus able to tailor subsequent screens to the location of the client 56. The system 40 stores a “cookie” on the computer which the client 56 is resident so that the system 40 can identify the location of the client 56 when necessary.

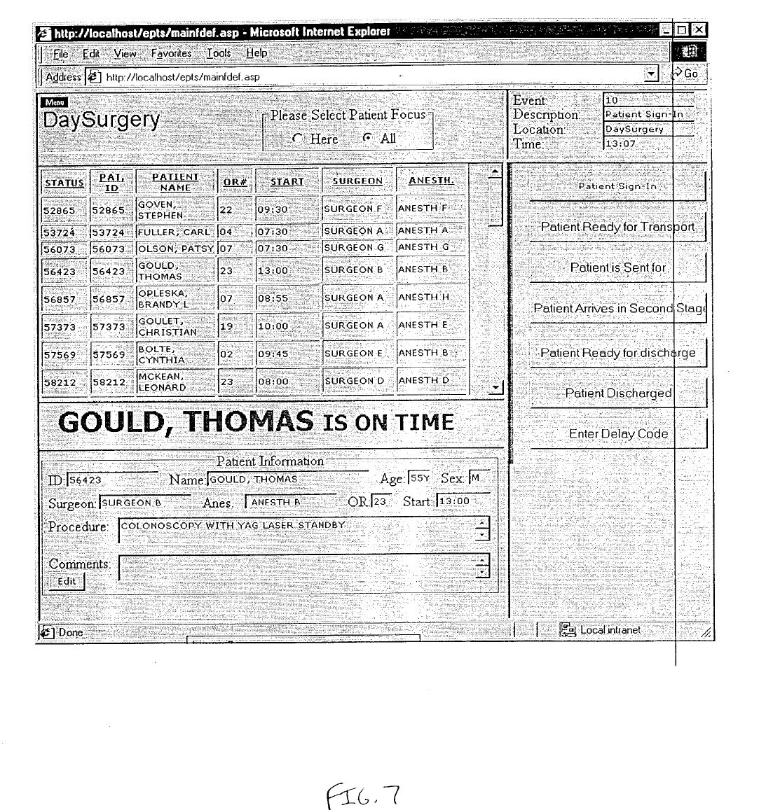

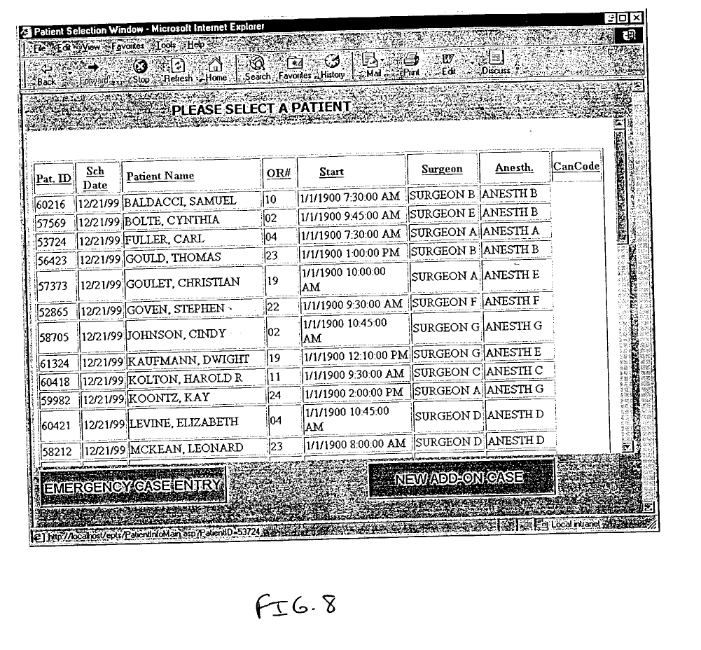

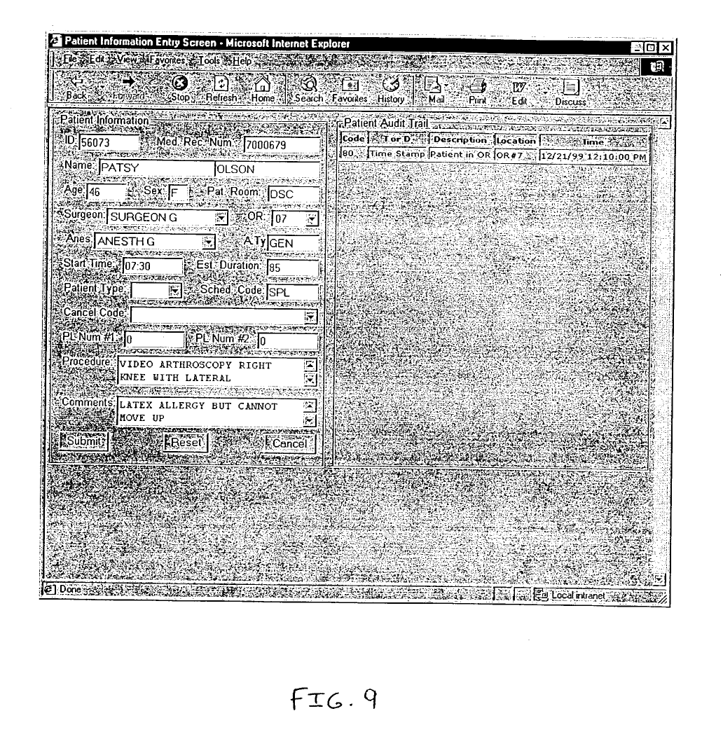

FIG. 6 is a screen printout which appears when the “Main Location Entry Screen” option is selected from the screen of FIG. 4. The screen illustrated in FIG. 6 appears when the client 56 is accessing the system 40 at a location other than an operating room. FIG. 7 is a screen printout which appears when a patient is selected from the screen of FIG. 6. FIG. 8 is a screen printout which appears when the “Patient Data Entry Screen” option is selected from the screen of FIG. 4. FIG. 9 is a screen printout which appears when a patient is selected using the screen of FIG. 8. In the screen that is displayed in FIG. 9, patient information could be modified.

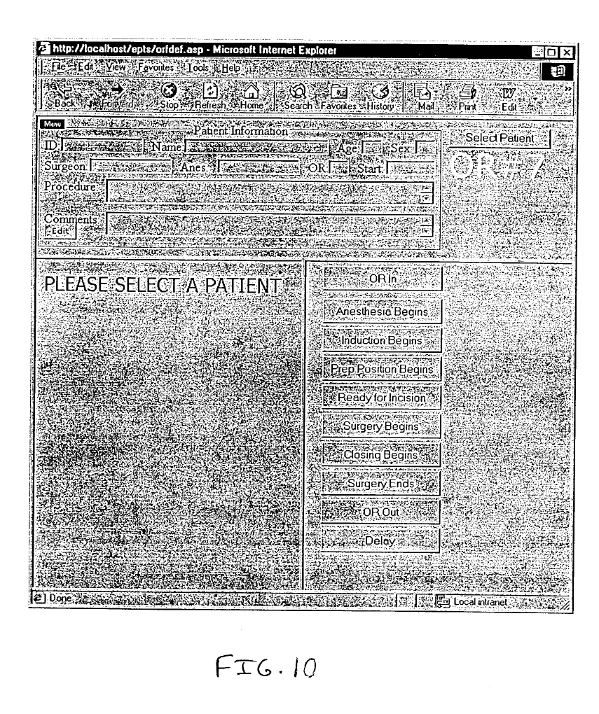

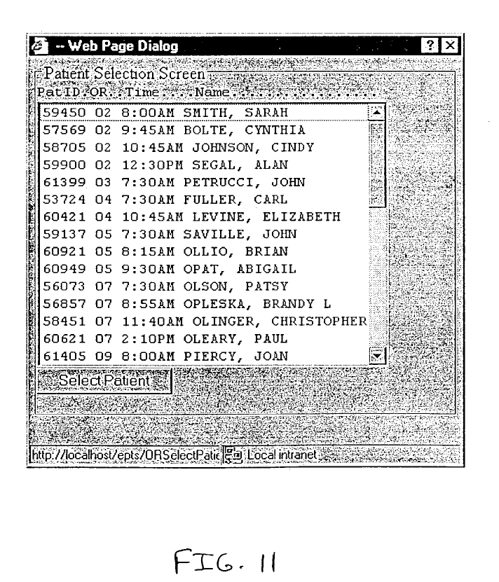

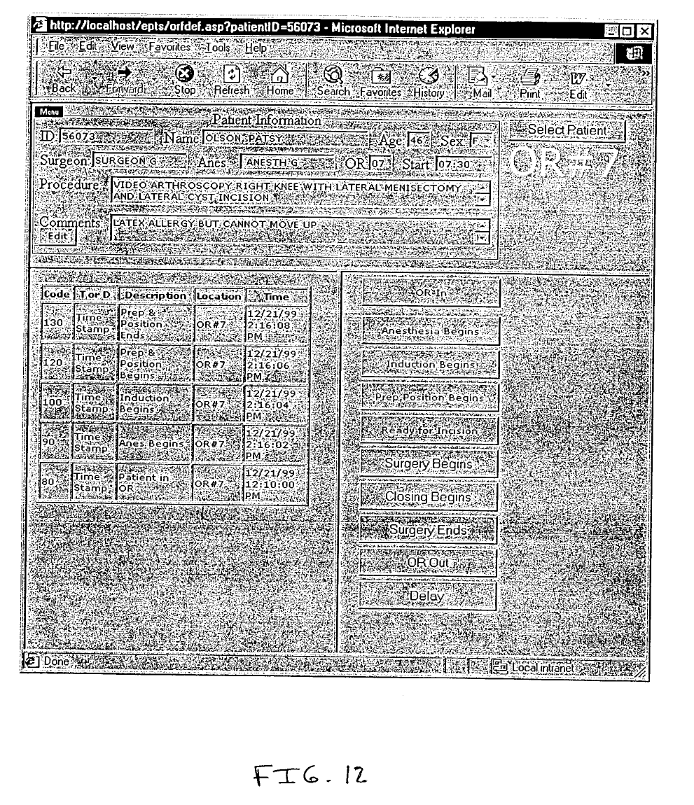

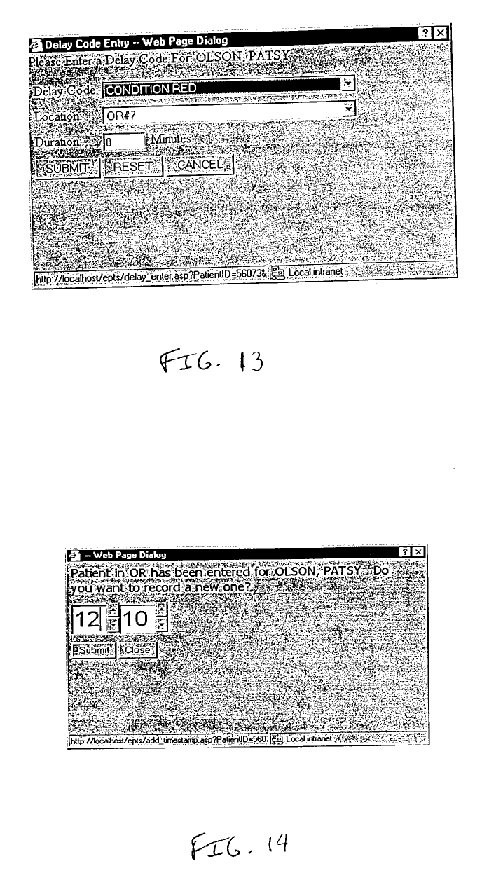

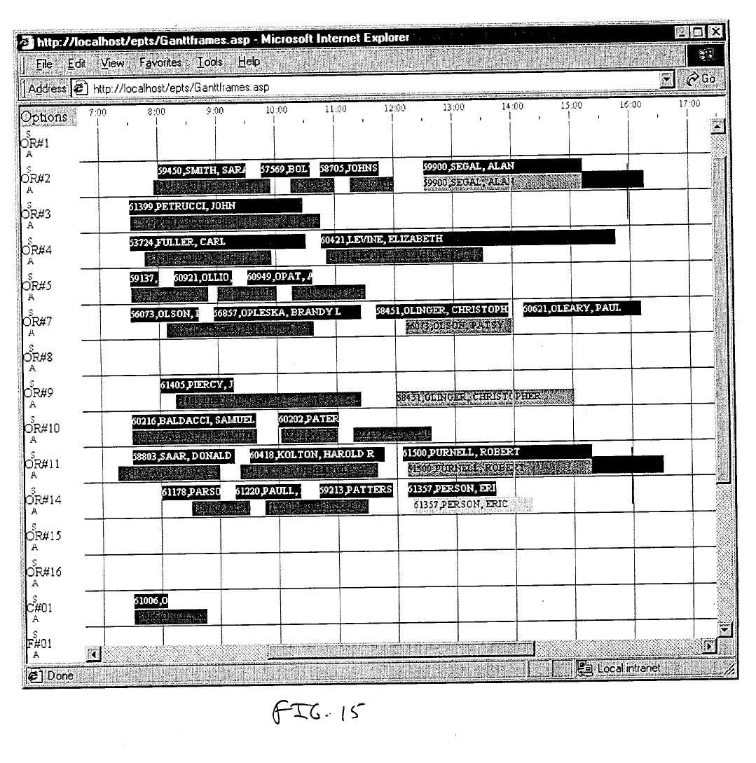

FIG. 10 is a screen printout which appears when the “OR Data Entry Screen” option is selected from the screen of FIG. 4. When the “Select Patient” option is selected, the screen appears as in the screen of FIG. 11. After a patient is selected from the screen of FIG. 11, the screen of FIG. 12 appears. If a delay is encountered in the patient's perioperative process, the “Delay” option can be selected from the screen of FIG. 12. After the “Delay” option is selected, the screen of FIG. 13 appears and allows the operator of the computer on which the client 56 is resident to enter a delay code and the duration of the delay. Upon entering the operating room, is the operator of the computer on which the client 56 is resident can enter a time stamp into the system 40. The client 56 can enter the time stamps listed on the screen in FIG. 12 in any order necessary or, if the process requires, the client 56 can enter multiple time stamps or retrospective time stamps. If the client 56 tries to enter multiple time stamps, the screen of FIG. 14 appears so that a multiple or retrospective time stamp may be entered.

FIG. 15 illustrates an example of a GANTT chart that appears when the “Gantt Chart” option from the screen of FIG. 4 is selected.

While the present invention has been described in conjunction with preferred embodiments thereof, many modifications and variations will be apparent to those of ordinary skill in the art. The foregoing description and the following claims are intended to cover all such modifications and variations, as well as any other applicable technologies which may appear in the future.

We claim:

1. A computer-assisted method of tracking a patient through a perioperative process, comprising:
entering a location of the patient into a patient tracking system;
entering at least one procedural time into the patient tracking system; and
tracking, via a terminal connected to a distributed computer network, the patient through the perioperative process based on the location of the patient and the procedural time.

2. The method of claim 1, wherein entering a location of the patient includes entering a location of the patient using data entry.

3. The method of claim 1, wherein entering a location of the patient includes registering the location of the patient using one of passive radio frequency data gathering and active infrared data gathering.

4. The method of claim 1, wherein entering at least one procedural time into the patient tracking system includes entering at least one procedural time into the patient tracking system via the distributed computer network.

5. The method of claim 4, wherein entering at least one procedural time into the patient tracking system via the distributed computer network includes entering at least one procedural time into the patient tracking system via one of the Internet and an intranet.

6. The method of claim 1, wherein tracking, via a terminal connected to a distributed computer network, includes tracking, via a terminal connected to one of the Internet and an intranet.

7. A computer-readable medium having stored thereon instructions which, when executed by a processor, cause the processor to perform the steps of:
accepting an entered location of a patient;
accepting, via a distributed computer network, at least one procedural time; and
tracking the patient through a perioperative process based on the location of the patient and the procedural time.

8. An apparatus, comprising:
means for accepting an entered location of a patient;
means for accepting, via a distributed computer network, at least one procedural time; and
means for tracking the patient through a perioperative process based on the location of the patient and the procedural time.

9. A patient tracking system, comprising:
a transaction server;
a page server in communication with the transaction server, the page server for communicating to at least one Internet-enabled client, the client for viewing information relating to the progress of at least one patient in a perioperative process;
a database server in communication with the transaction server; and
a time stamp collector for receiving time stamps from at least one piece of time stamp hardware.

10. The system of claim 9, further comprising an HL7 processor in communication with the database server.

11. The system of claim 9, further comprising a message generator in communication with the database server.
